(19) United States
(12) Patent Application Publication
(10) Pub. No.: US 2008/0202178 A1
(43) Pub. Date: Aug. 28, 2008

(54) Key Trapping Access Control System and Method

(76) Inventors: Christopher P. Lanz, Orange, CA (US); Dac Vu, Tustin, CA (US); Minh Bui, Tustin, CA (US)

Correspondence Address: PLAGER LAW OFFICES, 16152 BEACG BLVD., SUITE 207, HUNTINGTON BEACH, CA, 92647, US

(21) Appl. No.: 11/951,984

(22) Filed: Dec. 6, 2007

Related U.S. Application Data
(60) Provisional application No. 60/868,916, filed on Dec. 6, 2006.

(51) Int. Cl. E05B 47/08

(52) U.S. Cl. 70/278.3

(57) ABSTRACT

An automatic key trapping lock comprising a lock housing; a lock removable from the lock housing and further comprising a core with an internal lock assembly for trapping and releasing a key when a key is turned in a specified direction; a cam assembly comprising a cam member rotatably engaging the lock; a return spring biasing the cam member towards a key trapped position; said cam member operatively engages a locking and releasing solenoid with a plunger for locking and unlocking the cam member; and the locking and releasing solenoid is actuated by one or more control means operatively engaging the locking solenoid for locking or unlocking the cam. It is another object of the present invention to provide an adjustable key panel assembly having an adjustable cam for accommodating variable length locks.

### CROSS REFERENCE TO RELATED APPLICATION

This non-provisional application claims the benefit of previously filed provisional application No. 60/868,916 first filed on Dec. 6, 2006.

### BACKGROUND OF THE INVENTION

1. Field of the Invention

The invention relates in general to key control systems. More particularly, the invention comprises a key trapping, modular, access control system and panel.

2. Description of the Related Art

Access control systems for securing master and other keys are well-known in the art. These systems are used in office buildings, hospitals, apartment complexes, and other structures which require master key and other key security. Examples of master key panels that prevent the removal of keys in a keyway can be found in U.S. Pat. Nos. 5,505,066, 4,641,509, 5,970,761 and in systems such as those found in http://www.keywatcher.com/keywatcher/ where a master key panel with a plurality of keys is attached to the panel through the use of a circular ring. Embodiments such as those found at http://www.kewatcher.com/keywatcher/ can be programmed via an onboard console to release the applicable key and has the added feature of an indicator light to point the person using the key as to which key they need.

However, the problem with existing master key systems is that systems such as those of the KeyWatcher system use rings to secure the keys. Rings have been a huge problem in this field since they are easily cut with portable tools. Further, and more problematic, there is no way for the access control system to verify that the appropriate key has been replaced with the appropriate ring. What commonly results are that keys are often misplaced resulting in lost keys, delay in services, and money spent on locksmiths to replace lost or misplaced keys.

Other systems used in key prevention devices are those found in lockers and post office boxes that prevent the removal of keys once they have been inserted into their associated keyway. Examples of these are found in U.S. Patent Pub. No. 2001/0039819, 2001/0039819, 2004/0007032, and U.S. Pat. Nos. 7,051,563, 7,021,095, and 4,641,509. Yet, the problem with these devices that utilize key retention locks do so as a single access system (One user and key per lock) and are not controlled by a master control unit or access system. Further, these locks require the user to manually turn the key back to the trapped position.

Another class of locks is dedicated for use with doors (E.g., hospital doors) that utilize programmable magnetic cards capable of being swiped through card readers on the doors thereby allowing selective entry. Examples of these types of locks are found in U.S. Pat. Nos. 5,2917,66, 3,954,460, 6,840,071, 7,080,533, and German Patent Nos. 4002085, 4002093, and 4002085. Yet, in each of these cases, the cards enable access entry only for a selected user(s) to a room and the card is the key as opposed to comprising a master key system.

Another problem with current systems is their inability to adapt to scale and conformity with various locks, most particularly cylinder locks. Building administrators often wish to change the types of locks and add or subtract the number of keyed users that exist on the system. Currently, it is impossible to change the types of locks used without eliminating the entire key system since once a system is purchased, the purchaser is locked into the key locks of that system and the fixed scale imposed by the key system.

What is needed is a key system whereby a key panel houses keys that are retained in their keyway when not in use, automatically returns those keys to their trapped position when reinserted, is selectively controlled by a master control unit engaging the key panel to release those keys to specified users, and can validate that the appropriate key has been properly replaced. What is also needed is a truly modular access control system to allow for the scaling up or down of a key panel to allow for the addition or subtraction of key locks, and one that can adjust to varying length locks.

### SUMMARY OF THE INVENTION

An automatic key trapping lock comprising a lock housing; a lock removable from the lock housing and further comprising a core with an internal lock assembly for trapping and releasing a key when a key is turned in a specified direction; a cam assembly comprising a cam member rotatably engaging the lock; a return spring biasing the cam member towards a key trapped position; said cam member operatively engages a locking and releasing solenoid with a plunger for locking and unlocking the cam member; and the locking and releasing solenoid is actuated by one or more control means operatively engaging the locking solenoid for locking or unlocking the cam.

It is a further object of the present invention to provide an automatic key trapping lock of with a lock arm moveably engaging the solenoid plunger, a return spring arm engaging the cam assembly and the return spring, and a portion of the lock arm is formed to allow the return spring arm to bias into a locked position and prevent the lock arm from returning to an unlocked position; a receiving means for removably receiving and securing the solenoid plunger for locking and unlocking the cam; a control device for reading one or more magnetically readable and programmable cards or biometric data and, operatively engaging one or more card readers or biometric readers; or one or more indicators operatively engaging the one or more control devices.

It is another object of the present invention to provide an adjustable key panel assembly having an adjustable cam for accommodating variable length locks.

### BRIEF DESCRIPTION OF THE DRAWINGS

FIG. 1 is a schematic overview of a key trapping key panel with a plurality of key trapping locks operatively engaging a reader and network for controlling access to keys.

FIG. 2 is a rear view of a solenoid activated arm release for removing a trapped key from a lock with a return spring arm in an unlocked position.

FIG. 3 is a front view of a solenoid activated arm release for removing a trapped key from a lock with a key in an unlocked position.

FIG. 4 is a rear view of a solenoid activated arm release for removing a trapped key from a lock with a solenoid plunger extended to place the return spring arm into a locked position.

FIG. 5 is a front view of a solenoid activated arm release for removing a trapped key from a lock with a key in a locked position.

FIG. 6 is a rear perspective view of a cylinder from a cylinder lock exposing spring bias mechanisms for biasing the cylinder in a vertical position in a cylinder lock barrel.

FIG. 7 is a schematic of an access relay system connecting one or more key trapping locks to an access controller.

FIG. 8 is a side view of a removable proximity solenoid actuated key trapping lock in a retaining tube.

FIG. 9a is a side cross-sectional view of a proximity solenoid and sensors engaging one or more key trapping locks.

FIG. 9b is a front view of a proximity solenoid and sensors engaging one or more key trapping locks

FIG. 10 is an electrical diagram showing a proximity solenoid for trapping a key in a lock on a key panel.

FIG. 11 is an exploded view of a spring biased automatic key trapping lock utilizing a solenoid plunger directly engaging a cam and having an adjustable lock shaft.

FIG. 12a is a top view of a spring biased automatic key trapping lock utilizing a solenoid plunger directly engaging a cam and having an adjustable lock shaft and illustrating movement B-B.

FIG. 12b is a cross-sectional view of a spring biased automatic key trapping lock utilizing a solenoid plunger directly engaging a cam and having an adjustable lock shaft and having key movement Section B-B.

FIG. 13 is a top view of a spring biased automatic key trapping lock utilizing a solenoid plunger directly engaging a cam and having an adjustable lock shaft.

FIG. 14 is a side view of a spring biased automatic key trapping lock utilizing a solenoid plunger directly engaging a cam and having an adjustable lock shaft.

FIG. 15 is a front view of a spring biased automatic key trapping lock utilizing a solenoid plunger directly engaging a cam and having an adjustable lock shaft.

FIG. 16 is a bottom view of a spring biased automatic key trapping lock utilizing a solenoid plunger directly engaging a cam and having an adjustable lock shaft.

FIG. 17 is a rear view of a spring biased automatic key trapping lock utilizing a solenoid plunger directly engaging a cam and having an adjustable lock shaft.

FIG. 18 is an elevated perspective view of a spring biased automatic key trapping lock utilizing a solenoid plunger directly engaging a cam, having an adjustable lock shaft, and having a locking lever for locking a lock housing onto a key panel.

It should be understood that although these examples may describe some of the more specific features of the invention, they are given only for the purpose of illustration and the invention should not be construed as limited thereto.

### DESCRIPTION OF THE PREFERRED EMBODIMENTS

A complete understanding of this invention can be gained through reference to the drawings in conjunction with a thorough review of the disclosures herein.

### Key Access System

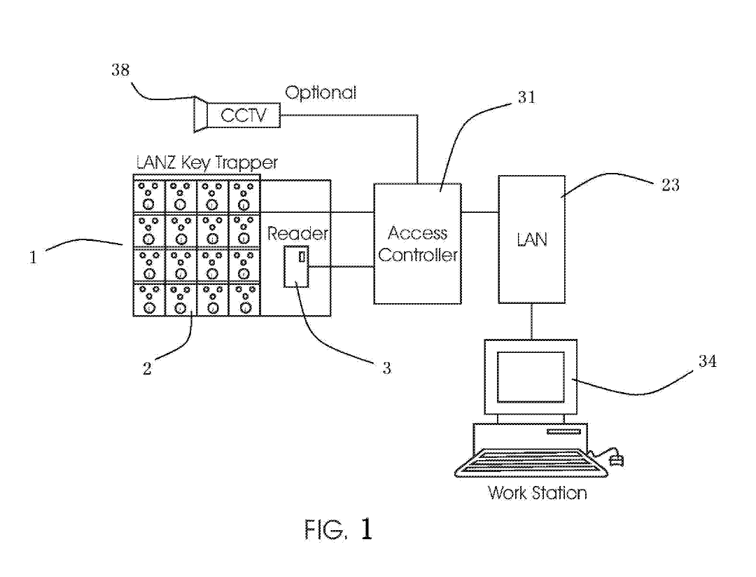

The present invention provides a novel key access system for automatically securing and releasing keys through key retention. In general, and as a system, the preferred embodiment as shown in FIG. 1 contains a central key panel or board 1 with one or more key trapping locks 2 engaged by a reader 3 preferably connected to an access control system 31 having an intelligent control software and hardware. The reader assembly 3 can be any known mechanism for reading data to identify a user. In a preferred embodiment a magnetic card (not shown) is programmed through a central access control system 31 that is connected to the reader assembly 3 through a network 23. For example, in an embodiment using a magnetic card, software and hardware interfaces of the access control system 31 can program a magnetic card with a variety of user information, send the data to the reader assembly 3 on the key panel 1 so that when a card engages the reader assembly 3 signals can be sent to locks 2 through leads engaging locks 2 for releasing one or more trapped keys based on user data.

There are a number of vendors who provide central access control system software and hardware for key access systems. These units are adaptable and configurable to meet existing security needs for the present invention. For purposes of the present invention, existing central access systems such as Kantech, Hirsch, Northern, Keri, Rosslare, Visonic, IEI, can be adapted and used with a key trapping key panel as disclosed herein. Therefore, much of the hardware and software benefits of these systems will naturally extend to the novelty of the present invention.

Typically, modern access control systems such as the ones just mentioned are mated with existing network systems to accommodate a broader range of security services such as sensors for monitoring open doors, surveillance cameras, and—specific to the present invention—master key systems. FIG. 1 shows a typical network topology working in conjunction with the present invention wherein a network 23 engages an access controller 31, an audio visual component 38, and a reader 3 and key trapping lock system 1. Alternately, the network topology can be configured in any known way, such as remote or wireless access to key panels, and engage any number of components in addition to audio visual components, such as door locking sensors and etc. In this way, programmable data can be entered at a central or remote location and sent to a reader onboard or in proximity to and engaging a key panel 1.

Further, there are a number of different ways in which a programmable interface of an access control system can be implemented. For example, instead of using a magnetic card and reader, known techniques for performing biometric scans (eyes, fingers, etc) can also be used. In this way, all programmable features can be accessed by a biometric reader for access by a user with the appropriate biometric data.

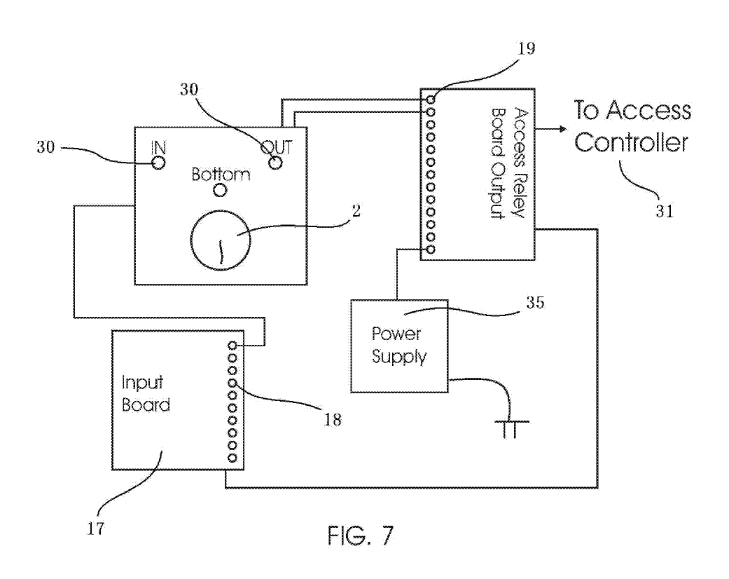

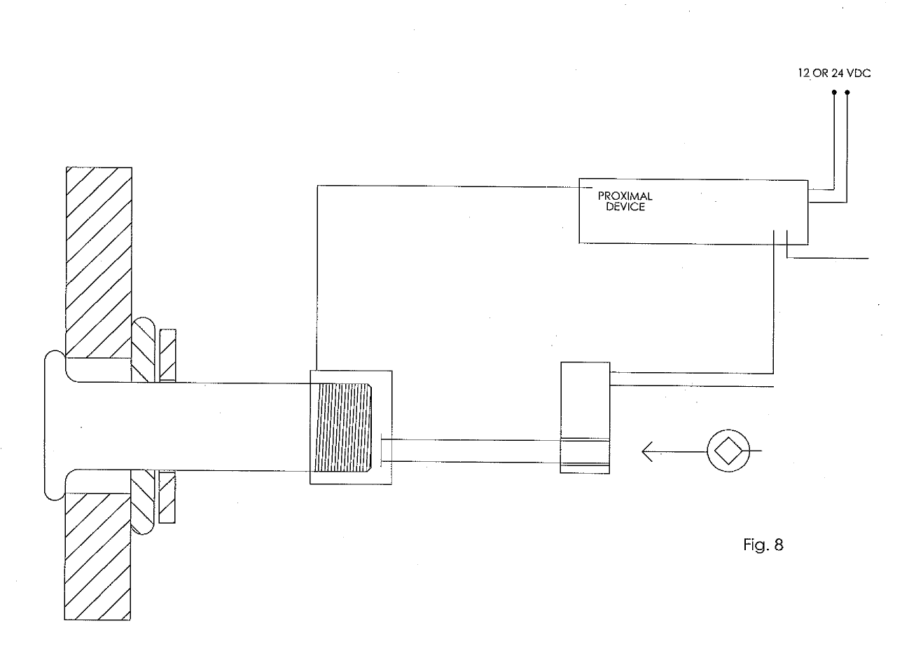

In its simplest embodiment, and as illustrated in FIG. 7, only one key retention lock is situated on a single key panel 1. Yet, because most buildings have many keys, and because those numbers of keys can grow, the capability to support a plurality of keys becomes critical. For that reason, a key panel 1 of the present invention also provides for scalable architecture as to the locks. This may be accomplished by adapting the scale of the key panel through input 17 and output 19 boards of varying size to accommodate desired scale.

FIG. 1, for example, illustrates how a key panel 1 can be outfitted with slots for accepting one or more key retention locks and FIG. 8 illustrates how each lock can be interchangeably fitted into separate housing channels.

As will be discussed in more detail below, individual lock housings may also be constructed to fit the varying lengths of standard cylinder locks by creating locks with slide adjustments. As such, key control system administrators can expand existing systems, replace broken lock housings within the system, or upgrade to different lock technologies.

### Automatic Key Trapping

One novel aspect of the present invention is its ability to automatically trap keys when they are reinserted into a lock keyway. Currently, keys are trapped by inserting a key into a lock and then manually rotating the key to release or engage a lock attached to the key cylinder. When the key is in the locked position, either a flange in the cylinder or tumblers will prevent the key from removal or counter-rotation. (See, U.S. Publication 2001/0039819 to McCurry) and an uneven sheer line “traps” the key preventing removal. However, to avoid the problem of requiring manual rotation of the key in the slot to lock the key, (rotation into a key trapped and locked position) this problem is overcome by incorporating a biased return spring. This may be accomplished in several ways: first, by coupling the return spring to an arm joined to a key cylinder to automate the key-trapping function; using a cam that directly engages a solenoid plunger; or through a proximity solenoid that senses the removal and insertion of a key.

The present invention adds to standard cylinder lock technology. A cylinder lock typically uses tumblers 16 with a spring biased against an internal keyway 24 of the cylinder. When a properly bitted (cylinder conforming) key is inserted into the keyway, the corresponding and matching ridges of the key bias against spring-biased tumblers to form a sheer line. Once the sheer line is formed and tumblers are aligned, a cylinder 14 can be rotated inside a barrel to engage known locking mechanisms. (E.g., a cam for turning a deadbolt) Beyond standard cylinder locks there are also provided key trapping locks which will lock the key in place when a cylinder 14 (See FIG. 6) is turned to a non-vertical or other devised position. However, for these locks to trap a key, a person re-inserting the key must manually turn the key to engage the locking mechanism or else the key will be able to be removed because the sheer line (in a cylinder lock) will remain intact and the locking flange (or other locking mechanisms) will not engage the lock.

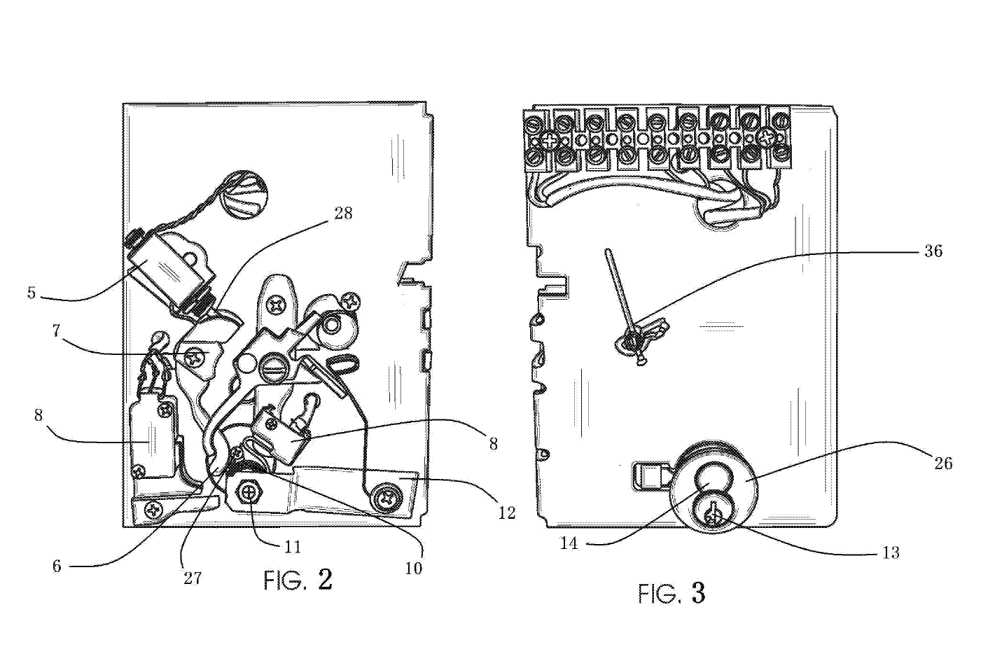

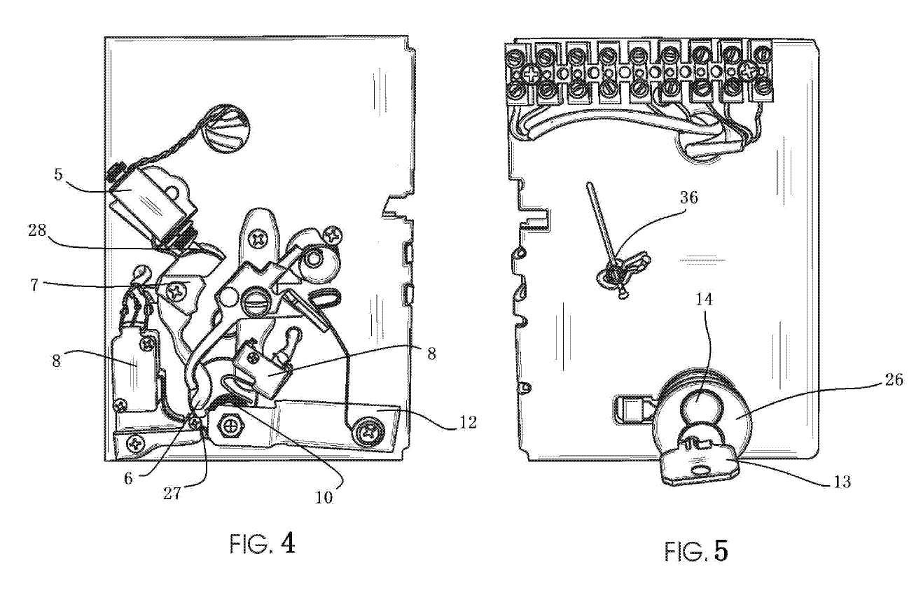

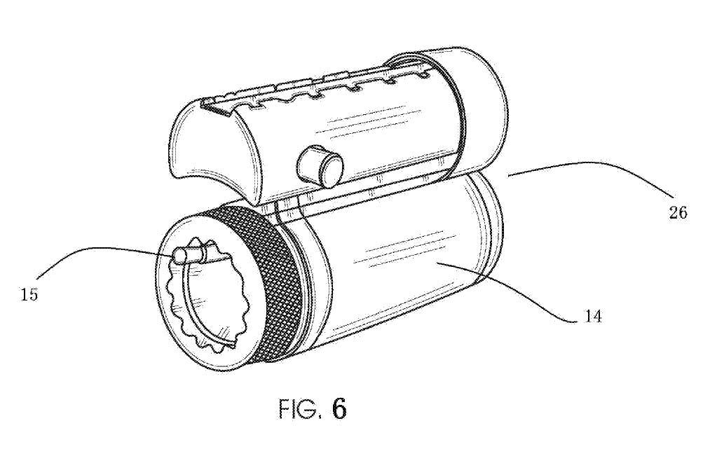

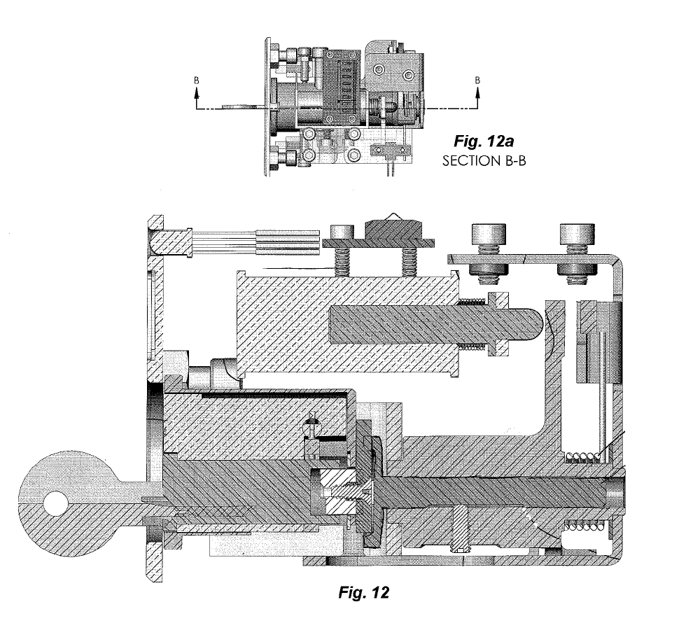

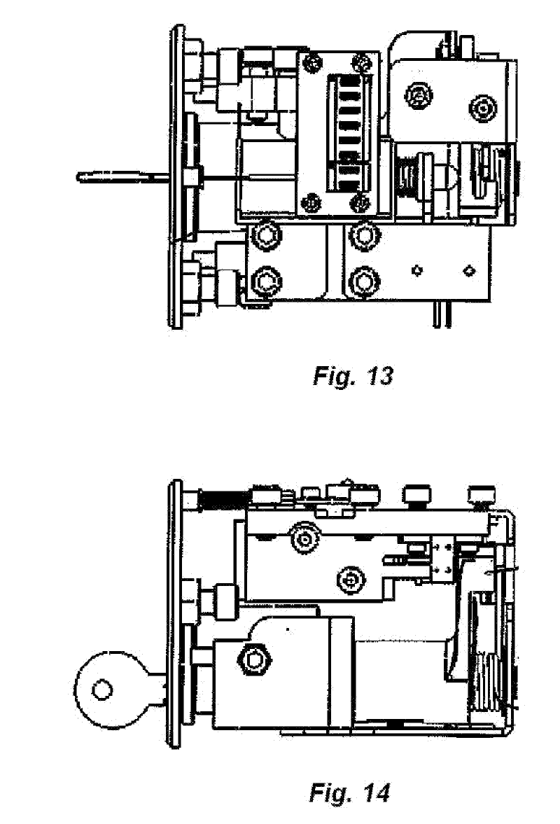

This problem is overcome in several ways, (FIGS. 2-5; FIGS. 6-9b; and FIGS. 11-12). In a first of these embodiments, (FIGS. 2-5) the present invention incorporates the use of a return spring 10 that biases a return spring arm 27 or cam 60 mounted to a rotating cylinder 14 of a cylinder lock 14 to bias arm 27 and rotating cylinder 14 toward a horizontal or “locked” position. Automatic biasing is accomplished through an automatic return spring function, whereby an optional cylinder lock screw 15 (FIG. 5) may be biased against external door and lock components such that when key tumblers form a sheer line keeping cylinder 14 is prevented from rotating to a horizontal position when the key 13 is removed or, in assisting in keeping the sheer line intact once a key 13 is reinserted. Once key 13 is replaced however, the tension of cylinder lock screw 15 can be released and the biased tension created by return spring 10 and return spring arm 27 turns cylinder 14 to a locked position. When return spring arm 27 is biased downward, it slides below the slope of a lock arm 6 preventing a key from turning cylinder 14 back toward a vertical or unlocked position. FIGS. 1 and 2 show a key 13 and return spring arm 27 simultaneously biased horizontally. Lock arm 6 prevents return spring arm 27 from being turned by key 13 to a vertical position.

To remove key 13, lock arm 6 can be mounted to an arm support pivot 7 so that lock arm 6 can be rotated to allow return spring arm 27 and cylinder 14 to be rotated back toward a vertical, unlocked position. Lock arm 6 is automatically rotated by a plunger 28 connected to a solenoid 5. When solenoid 5 is actuated, plunger 28 is forced against lock arm 6, partially rotating it around pivot 7 to allow return spring arm 27 to be rotated back to the unlocked position. Solenoid 5 can be actuated by many known manual or access control systems. In a preferred embodiment, a card reader assembly 3 is mounted to a key panel 1 so that a programmable magnetic card can be “swiped” across or through the assembly thereby activating lock arm solenoid 5.

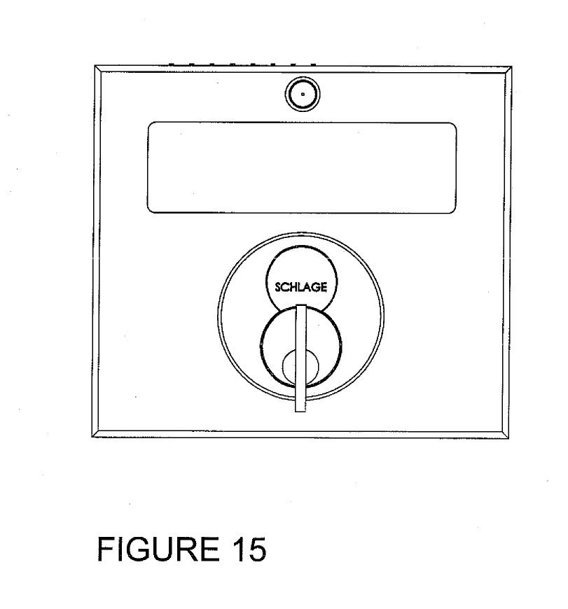

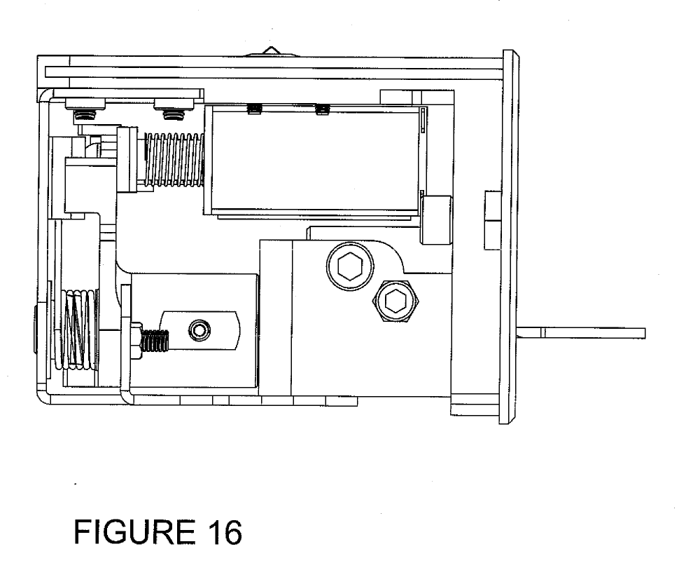

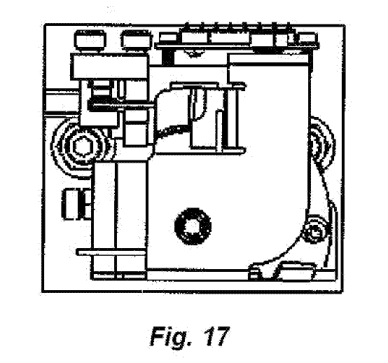

Alternatively, and as shown in FIGS. 11-17, instead of a plunger engaging a sloped lock arm 6 that is separate from the cam and spring locking assembly, a rotating cam member 60 with an aperture 61 (Or, in the alternative, a groove, recess or magnet, clamp) sufficient to accommodate a spring biased 282 solenoid plunger 280 that directly engages the cam member 60 when a solenoid 281 is actuated. Starting from a key 130 trapped position (which for the purposes of illustration is parallel to the ground), key 130 is trapped—unable to be removed—due to an uneven shear line internal to the cylinder lock—and cannot be rotated to a position perpendicular to the ground because the solenoid plunger 280 is in a locked position and extended into aperture 61 of cam member 60. To remove key 130, solenoid 281 is actuated through a control mechanism (E.g., magnetic card reader or biometric scanner programmed to release keys based on selected criteria) thereby retracting plunger 280 and freeing cam member 60 to rotate key 130 to a perpendicular and unlocked position (as shown) created by an even sheer line and allowing removal of key 13. Plunger 280 is spring biased and rides on cam surface after the initial activation and will extend into aperture 61 when proper rotation is achieved. Actuation of plunger 280 can be timed to extend back through action of spring 282 after a specific period of time.

When key 130 is removed, as in the other embodiments, an uneven sheer line is created preventing a spring bias from rotating a cam back to a locked and trapped position. When key 130 is reinserted cylinder 280 rotates back toward a key trapped position and plunger 280 reinserts into cam aperture 61.

In another exemplary embodiment, each lock 2 can be associated with input 18 and output 19 controls that feed into an access control unit 31. This can be accomplished either through various types of sensors 8 284 on the panel 1 to each lock 2 or, through separate sensors 8 284 associated with each lock 2 in a multiple lock embodiment. For example, exemplary embodiments include using single pull double throw switches to control LED and key contact internal to a lock to effect numerous status messages or indicators either on the front of the lock itself or as signals sent remotely or to a remote location. In this way, and in view of the embodiment incorporating a return spring arm, status indicators 30 joined to the sensors 8 284 can create an interface (lights, alarms, and etc.) on the panel, adjacent to the appropriate lock, on a lock faceplate 285, or otherwise capable of indicating various status' to the user when each sensor 8 284 or its relative status indicator 30 is engaged, directly or indirectly. Indicators 30 can include LED's or other illuminating or digital elements onboard panel 1, faceplate 285 or, can include leads back to central access control software of access controller 31 that can then notify appropriate persons through various electronic techniques available in the art and novel in light of the present invention.

For example, and as shown in FIGS. 1 and 3, status indicator 8 can be connected (wired or otherwise) to an access control system. Status indicator 8 can also engage and sense a position of return spring arm 27 or whether a key is in cylinder 14 to indicate to a user interface whether a key is in a locked or unlocked position. This can be done by return spring arm 27 engaging a status indicator directly or through the use of the return spring arm engaging a switch. (not shown) In this way, when a user activates a reader 3 on a panel 1 to return a key 13, an appropriate indicator (E.g., LED) is illuminated, sounded, or other electronic signal sent to a central access system. If a key is inserted and if the key is not inserted properly or there is a malfunction whereby the status switch has not been engaged by the return spring arm, the indicator light can continue to be illuminated acting as a warning to ensure the proper return of the key. Further, a separate indicator light (also not shown) can be illuminated; or an alarm can be activated indicating to the user or a remote system that a key is not properly inserted.

Alarms and notifications will vary with each access system design. Most access systems have alarm and notification capabilities (E.g., email or alarm outputs that trigger outside sounders) It can also be hooked up to an alarm system and monitored by a central station that would notify those responsible for monitoring the access control system.

Alternatively, if a key is not resubmitted to an appropriate lock on the panel within a specified period of time, an alarm with a timing mechanism and engaging the status indicator can sound either a physical alarm or even a software alarm of the intelligent control system. Those in the art will readily appreciate the number of different embodiments possible. Typically, key access software has timers built into the software for events such as propped door times, door unlock times and etc. In a preferred embodiment, the present invention would extend standard time from seconds to hours. Therefore, if a key is not returned within the time period the access system will send a programmed response to status indicators 30 or to the access software itself.

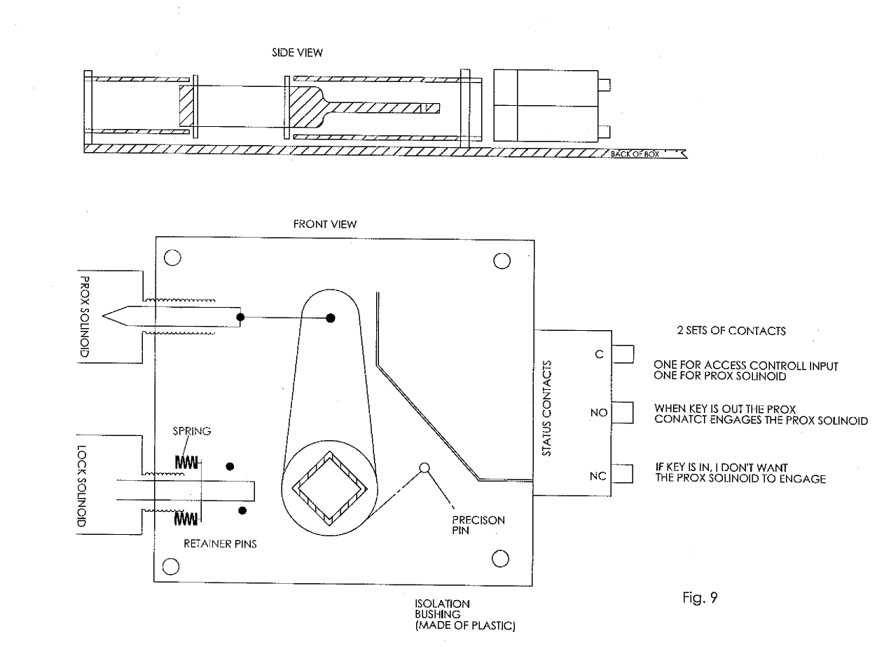

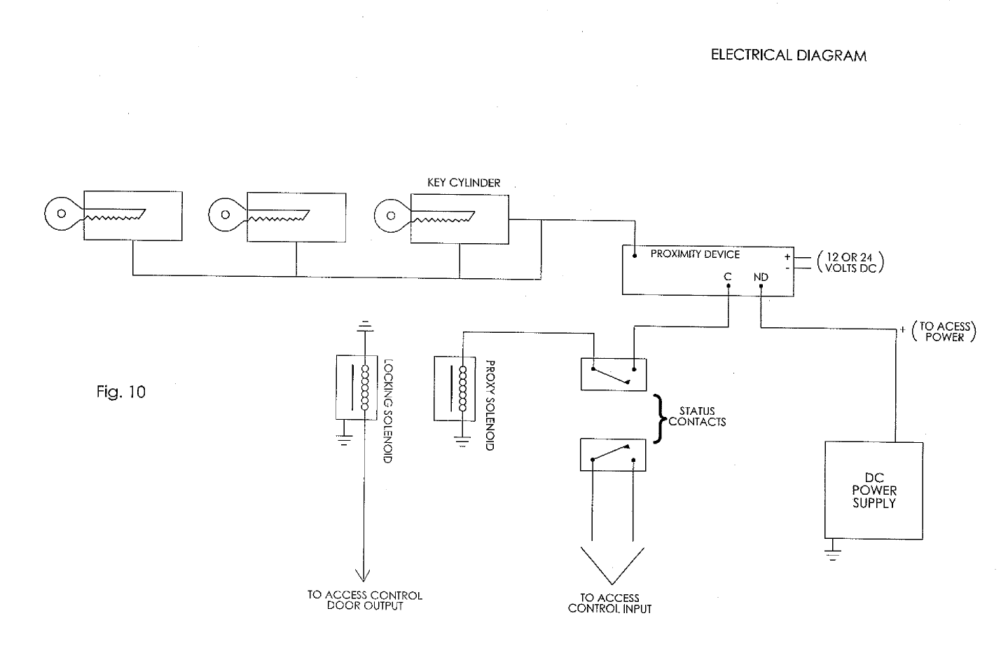

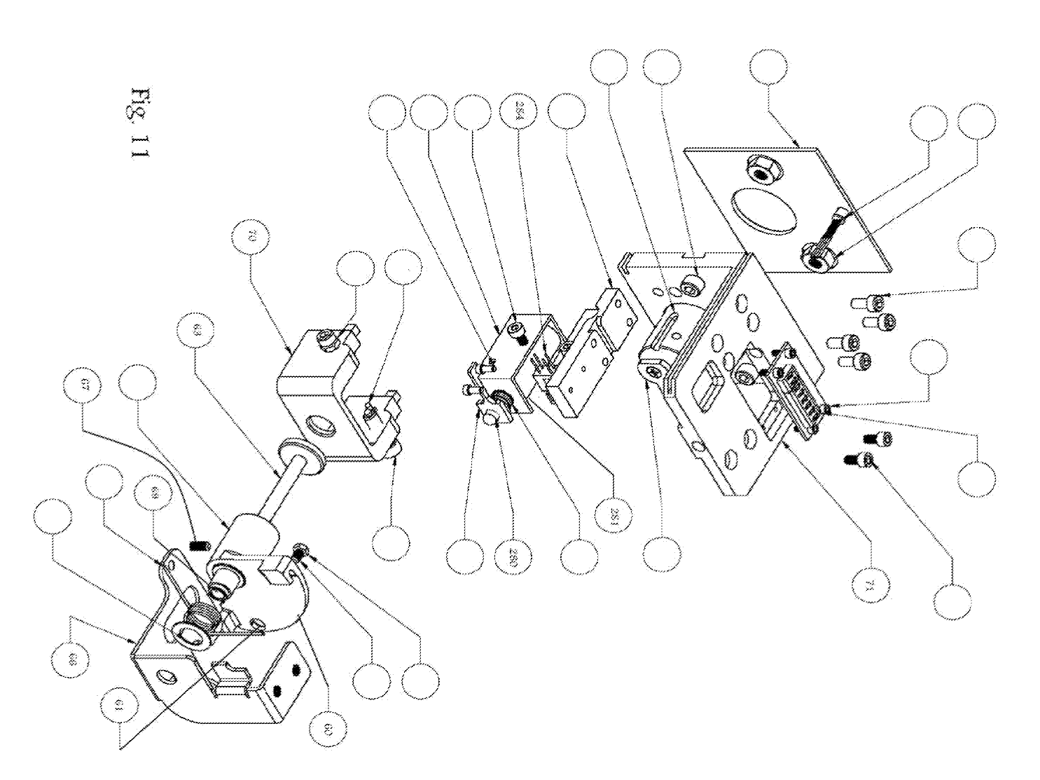

In another preferred embodiment for trapping locked keys and as shown in FIGS. 8, 9a, and 9b, a return spring solenoid 32 is actuated by a circuit completed by the insertion of a key 13 engaging a cylinder lock 2. Similar to the return spring embodiment described above, a proximity solenoid 32 is mounted to a panel 1 with a proximity solenoid plunger 33 engaging a proximity solenoid lock arm 37. When a key is returned to a keyway, it leads to solenoid 32 to complete a circuit and a plunger is extended, releasing lock arm 37, thereby allowing the key cylinder to rotate. Once rotated, it is prevented from counter-rotation through the lock arm and not released from the trapped position until a reader is activated.

Further, it is also desirable to have a single solenoid act as both a lock and proximity solenoid engage and disengage a single lock arm to trap and un-trap a key in a lock. When a key is locked in a keyway of a cylinder lock, a lock arm 6 prevents return arm 27 from being returned to create a sheer line and allow release of a key. Then once a card or other biometric member is swiped or scanned, lock arm 6 is released and a second arm 37 pivotally engaged with a second plunger on proximity (or circuit) solenoid 32 and return spring arm 27 locks return spring arm 27 in place to prevent it from instantly returning to a trapped position and the key can be removed from its cylinder. When a key or conductor then touches the key cylinder, a circuit (FIG. 8, leads 289 from the cylinder to the solenoid and panel component) is completed causing proximity solenoid 32 to actuate a proximity solenoid plunger 33 to move second arm 37 away from return spring arm 27 allowing it to move to the trapped position when the proper key is inserted creating a sheer line and allowing the cylinder to turn in the barrel. In this way, any optional flanges or nipples biased against the panel components to prevent the barrel from rotating are unnecessary. Vice versa, solenoids and plungers can act in opposing ways to achieve the same result.

In another preferred embodiment for trapping automatically trapping keys and as shown in FIGS. 9a and 9b, a spring lock solenoid 50 and spring arm 51 engages a lock bushing 53 that releasably engages a lock channel 56 on the bushing. The lock bushing 53 also engages a pivotal arm 54 that is biased toward a sensor 55 by a proximity solenoid 58 when a key is removed from a keyway of the lock. In this position the position is shorted and a plunger 59 in constant engagement with the arm 54 remains extended so that arm 54 remains in contact with a sensor 60 connected to I/O contacts 61 for determining key status. When a key is reinserted into the keyway, a circuit is completed and plunger 59 is retracted rotating the arm 54 back towards the spring arm 51 which once the channel 56 rotates sufficiently toward the spring arm 54, the spring biases the end of the arm into the channel and locks or traps the key in place until another scan or read of a card is made.

FIG. 9b shows a bushing 64 and groove into which a shaft 630 can extend. The lock can then be inserted into a lock housing 650 and then locked in place. By having a rotatable shaft 53, its rotating motion and that of the cylinder is transferred to a return spring arm allowing it to turn to a trapped or un-trapped position. The shaft can be detachable from the cylinder and the panel to allow for interchangeability and easy removal of the lock. However, to avoid unwanted solenoid activation through inadvertent touching of other parts of the panel, non-conductive bushings (plastic, and etc) can be fitted around the shaft portion that fits into the locking groove 640 (or, the structure of the groove can be formed of a non-conductive material) and in the same way a non-conductive bushing 660 can be formed around the interior of the key lock housing to prevent the key housing from contacting any conductive components of the panel.

### Scalable Architecture

Another benefit of the present invention is its ability to provide for scalability. This can be accomplished through a modular key panel design whereby either key locks or key panels can be removed from the key panel. In this way, locks can be replaced quickly, easily, and without having to purchase and upgrade to an entirely new key system and, whole panels can provide for added scalability and can be added to accommodate two or more locks.

A modular design with the capability of having interchangeable locks is illustrated in FIGS. 11 and 12. A cam shaft 63 is preferably rotatably joined to a cam 60 and that can be adjusted through manual sliding of the cam and a cam drive 110 a rear tap screw 69 and then secured in place through a set screw 67 engaging a d-slot 105 on or attached to cam shaft 63. Adjustment is accomplished by releasing set screw 67 and adjusting cam shaft 63 to accommodate various length cylinder locks resting in cylinder lock housing 70 71 comprised of either a single frame or, a multi-frame assembly as is shown in FIG. 11. Frame assembly in FIG. 11 illustrates rear housing member 70 and front housing member 71 that can be adjusted or formed to accommodate the longest cylinder housing available. Likewise, cam shaft 63 can also be specified to accommodate any desired length so that it can adjust to desired cylinder lengths.

As alternative method for adjusting cam shaft 63, external threading on cam shaft 63 and internal threading in drive 110 can be used to allow for the adjustment of cam shaft 63 through a rear tap screw adjustable from the back of the lock assembly. To prevent cam shaft 63 from rotating when a key is turned in cylinder 283, a counter-locking nut can be fitted on the cam shaft 63.

To accommodate all the various manufacturers of locks, specifically, cylinder locks, a universal b-tail cam 112 can be fitted onto the back of cylinder 283 thereby allowing cam assembly to rotatably secure to any cylinder lock through a mated cam fitting 113 using the novel cam approach of the present invention.

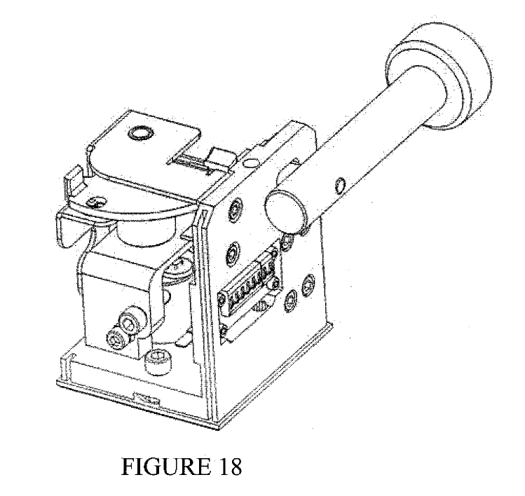

To enable interchangeable lock housing, a panel may be constructed to lock in a plurality of lock housings of the various embodiments described above. This is generally accomplished by incorporating a locking lever 100 that mates with a locking knob 102 engaging a lock housing solenoid 101 and as illustrated in FIG. 18. Similar to the solenoid actuation of locking solenoid 280 and 5 disclosed above, solenoid 101 can either be independently actuated or programmed into a magnetic key card, biometric scanner, or other control device, and in addition to features described above.

The above disclosures and drawings are merely illustrative of the present invention and do not claim to represent all of its numerous embodiments. Those skilled in the art will appreciate many other ancillary embodiments that flow from the novelty of the present invention contained herein.

I claim:

1. An automatic key trapping lock comprising:
a lock housing;
a lock removable from the lock housing and further comprising a core with an internal lock assembly for trapping and releasing a key when the key is turned in a specified direction;
a cam assembly comprising a cam member rotatably engaging the lock;
A return spring biasing the cam member towards a key trapped position;
said cam member operatively engages a locking and releasing solenoid with a plunger for locking and unlocking the cam member; and
The locking and releasing solenoid is actuated by one or more control means operatively engaging the locking solenoid for locking or unlocking the cam.

2. The automatic key trapping lock of claim 1 wherein the cam assembly further comprises a lock arm moveably engaging the solenoid plunger, a return spring arm engaging the cam assembly and the return spring, and a portion of the lock arm is formed to allow the return spring arm to bias into a locked position and prevent the lock arm from returning to an unlocked position.

3. The automatic key trapping lock of claim 1 wherein the cam member further comprises a receiving means for removably receiving and securing the solenoid plunger for locking and unlocking the cam.

4. The automatic key trapping lock of claim 1 wherein the control means further comprises one or more processors for reading one or more magnetically readable and programmable cards and, operatively engaging one or more card readers.

5. The automatic key trapping lock of claim 1 wherein the control means further comprises one or more processors for interpreting biometric data and operatively engaging one or more biometric readers.

6. The automatic key trapping lock of claim 1 wherein the housing further comprises one or more indicators operatively engaging the one or more control means wherein said one or more control means further comprises one or more processors engaging one or more sensors for sensing one or more desired features and engaging the one or more indicators to indicate the one or more desired features.

7. A key panel assembly having an adjustable cam for accommodating variable length locks comprising:
A lock housing;
a lock removable from said housing and adapted to receive a key; and
a rotatable cam assembly adapted to engage and secure a slidably adjustable cam shaft detachably connected to a connection member engaging the lock, and operatively engaging a locking member for securing said cam shaft.

8. The key panel assembly of claim 7 wherein:
The lock comprises a cylinder lock with an internal lock assembly for trapping and releasing the key when the key is turned in a specified direction;
the cam assembly further comprises a cam member rotatably engaging the lock and a return spring biasing the cam member towards a key trapped position;
said cam member operatively engages a locking and releasing solenoid with a plunger for locking and unlocking the cam member; and
The locking and releasing solenoid is actuated by one or more control means operatively engaging the locking solenoid for locking or unlocking the cam.

9. The key panel assembly of claim 7 wherein:
the lock further comprises a cylinder lock with an internal lock assembly for trapping and releasing a key when the key is turned in a specified direction;
the cam member further comprises a receiving means for removably receiving the solenoid plunger for locking and unlocking the cam.

10. The key panel assembly of claim 7 wherein the control means further comprises one or more magnetically readable and programmable cards and, one or more card readers.

11. The key panel assembly of claim 7 wherein the control means further comprises one or more programmable biometric readers.

12. The key panel assembly of claim 7 wherein the housing further comprises one or more indicators operatively engaging the one or more control means and wherein said one or more control means further comprises programmable logic for sensing one or more desired features and engaging the one or more indicators to indicate the one or more desired key features. [SENSORS]

13. The key panel assembly of claim 7 wherein the cam assembly further comprises a threaded cam shaft threadably connectable to a cam drive and a counter-locking nut.

14. An automatic key trapping lock comprising:
A Lock housing;
A lock removable from said housing and adapted to receive a key and further comprising a core with an internal lock assembly for trapping and releasing a key when the key is turned in a specified direction;
A cam assembly comprising a rotatable cam adapted to engage and secure a cam shaft detachably connected to a connection member rotatably engaging the lock, and operatively engaging a locking member for securing said cam shaft.
A return spring biasing the cam member towards a key trapped position;
Said cam member operatively engages a locking and releasing solenoid with a plunger for locking and unlocking the cam member; and
the locking and releasing solenoid is actuated by one or more control means operatively engaging the locking solenoid for locking or unlocking the cam.

15. The automatic key trapping lock of claim 14 wherein:
The lock comprises a cylinder lock with an internal lock assembly for trapping and releasing the key when the key is turned in a specified direction;
The cam assembly comprises a biased return spring biasing the cam assembly towards a key trapped position;
Said cam member operatively engages a locking and releasing solenoid with a plunger for locking and unlocking the cam member; and
The locking and releasing solenoid is actuated by one or more control means operatively engaging the locking solenoid for locking or unlocking the cam.

16. The automatic key trapping lock of claim 14 wherein:
the lock comprises a cylinder lock with an internal lock assembly for trapping and releasing a key when the key is turned in a specified direction;
the cam assembly further comprises a cam member comprising a receiving means for removably receiving the solenoid plunger for locking and unlocking the cam.

17. The automatic key trapping lock of claim 14 wherein the control means further comprises one or more magnetically readable and programmable cards and, one or more card readers.

18. The automatic key trapping lock of claim 14 wherein the cam assembly further comprises a threaded cam shaft threadably connectable to a cam drive and a counter-locking nut.

19. The automatic key trapping lock of claim 14 wherein the cam assembly further comprises a lock arm moveably engaging the solenoid plunger, a return spring arm engaging the cam assembly and the return spring, and a portion of the lock arm is formed to allow the return spring arm to bias into a locked position and prevent the lock arm from returning to an unlocked position.

20. The automatic key trapping lock of claim 14 wherein the cam member further comprises a a receiving means for removably receiving and securing the solenoid plunger for locking and unlocking the cam.
